(19) United States
(12) Patent Application Publication
(10) Pub. No.: US 2010/0027402 A1
(43) Pub. Date: Feb. 4, 2010

(54) OPTICAL HEAD DEVICE AND OPTICAL DISC APPARATUS

(75) Inventors: Katsuo IWATA, Yokohama-shi (JP); Kazuhiro NAGATA, Yokohama-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/488,297

(22) Filed: Jun. 19, 2009

(30) Foreign Application Priority Data
Jul. 31, 2008 (JP) 2008-198774

(51) Int. Cl. G11B 7/00

(52) U.S. Cl. 369/109.01; G9B/7

(57) ABSTRACT

An optical head device includes: a diffraction unit including a plurality of diffraction portions each diffracting a incident light in a given direction, the light beam being reflected by an optical disc; and a photodetection unit including a plurality of photodetectors each outputting a signal corresponding to an intensity of an irradiated light, wherein the photodetectors include at least two first photodetectors for generating a compensation value to compensate a tracking error signal, and wherein the diffraction portions include at least two first portions for focusing the incident light into the first photodetectors.

### CROSS-REFERENCE TO RELATED APPLICATIONS

This application is based upon and claims the benefit of priority from Japanese Patent Application No. 2008-198774, filed Jul. 31, 2008, the entire contents of which are incorporated herein by reference.

### BACKGROUND

1. Field

The present invention relates to an optical head device for recording information in an optical disc or reproducing the information and an optical disc apparatus using the optical head device.

2. Description of the Related Art

Optical discs having plural types of recording densities which are referred to as a CD (Compact Disc) standard or a DVD (Digital Versatile Disc) standard have already spread widely. In recent years, there have also been practically used optical discs having a BD (Blue-ray Disc) standard and an HD DVD (High Definition Digital Versatile Disc) standard which are extra high density optical discs in which information is recorded by using a laser beam having a violet wavelength to further increase a recording density.

As one of techniques for increasing a storage capacity of the optical disc, it has been proposed to provide a plurality of (for example, two) recording layers on a single side of the disc and to move an objective lens of an optical head device in a direction of an optical axis to focus a beam on the respective layers, thereby carrying out recording or reproduction for each recording layer. In order to prevent a spherical aberration from being increased, it is preferable that a distance between the recording layers should be small. When the distance between the recording layers is small, however, a leakage of a signal from the other recording layer, that is, an interlayer cross talk is generated. For this reason, in a single-sided multilayer disc, the respective layers are disposed close to each other within a range in which an influence of the interlayer cross talk and the spherical aberration is rarely exerted.

In the single-sided multilayer disc, however, a reflected light in a blurring state is irradiated on a PD to be a photo detector from the recording layer on which the beam is not focused, and a signal of the interlayer cross talk enters a servo signal and an RF signal which are output from the optical head device so that an SN ratio is reduced. For a method of solving the disadvantage, JP-A-2000-251305 has described a reduction in a light receiving area of the PD, for example.

In JP-A-2000-251305, the structure including a hologram element which is divided into four regions through two straight lines in tangential and radial directions of an optical disc and in which the regions disposed diagonally are constituted as first and second hologram pair regions having the same construction, and a light receiving element substrate which has first and second light receiving regions for receiving a ± primary diffracted light from the first hologram pair region and third and fourth light receiving regions for receiving the ± primary diffracted light from the second hologram pair region and in which each of centers of the first to fourth light receiving regions and a convergent point of a reflected light are disposed in positions at almost optically equal distances from a center of the hologram element, and the first to fourth light receiving regions are divided into three parts including a central divided region and two end divided regions at both sides.

By decreasing a light receiving area of a PD, it is possible to reduce an interlayer cross talk signal for a focus signal or a track signal which is a servo signal, or an RF signal. If the light receiving area of the PD is excessively decreased, however, it is hard to assemble and adjust an optical head device. As a result, there is a possibility that a reliability might be reduced greatly. For this reason, it has been desired to suppress an interlayer cross talk while ensuring an easiness of the assembly and adjustment.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a schematic structure of an optical disc apparatus according to an embodiment of the invention,

FIG. 2 is an exemplary view showing an arrangement of a diffracting region of a diffracting element,

FIG. 3 is an exemplary view showing an arrangement of a photodetecting element of a photodetecting portion,

FIG. 4 is a chart showing a simulation result of a cross talk of a recording/non-recording boundary from another layer,

FIG. 5 is a chart showing a relationship between a size of a cell of a PD and a cross talk quantity, and

FIG. 6 is a chart showing a simulation result of a cross talk of a recording/non-recording boundary from another layer in the case in which the diffracting element is used.

### DETAILED DESCRIPTION

Various embodiments according to the invention will be described hereinafter with reference to the accompanying drawings. In general, according to an aspect of the invention, an optical head device includes: a diffraction unit including a plurality of diffraction portions each diffracting a incident light in a given direction, the light beam being reflected by an optical disc; and a photodetection unit including a plurality of photodetectors each outputting a signal corresponding to an intensity of an irradiated light, wherein the photodetectors include at least two first photodetectors for generating a compensation value to compensate a tracking error signal, and wherein the diffraction portions include at least two first portions for focusing the incident light into the first photodetectors.

According to another aspect of the invention, an optical disc apparatus includes an optical head device and a control unit configured to perform processing of a signal output from the optical head device, an optical head device comprising: a diffraction unit including a plurality of diffraction portions each diffracting a incident light in a given direction, the light beam being reflected by an optical disc; and a photodetection unit including a plurality of photodetectors each outputting a signal corresponding to an intensity of an irradiated light, wherein the photodetectors include at least two first photodetectors for generating a compensation value to compensate a tracking error signal, and wherein the diffraction portions include at least two first portions for focusing the incident light into the first photodetectors.

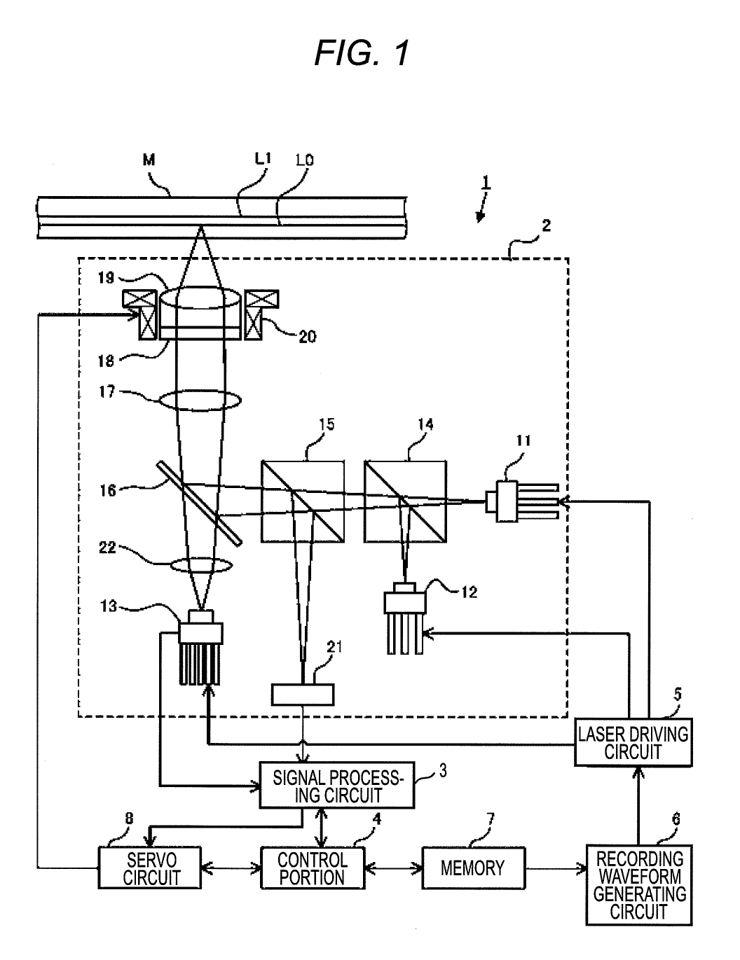

An example according to the invention will be described below with reference to the drawings. FIG. 1 is a diagram showing a schematic structure of an optical disc apparatus according to an embodiment of the invention. An optical disc apparatus 1 includes an optical head device 2, a signal processing circuit 3, a control portion 4, an LD driving circuit 5, a recording waveform generating circuit 6, a memory 7, and a servo circuit 8.

The optical disc apparatus 1 collects a laser beam emitted from the optical head device 2 onto an information recording layer of an optical disc M and records and reproduces information. The optical disc M has two recording layers, for example, an L0 layer and an L1 layer in order from a substrate surface of the optical disc, and the laser beam is collected onto either of the recording layers.

A light reflected from the optical disc M passes through an optical system of the optical head device 2 again and is detected as an electric signal through a photo detector (a DVD/HD DVD/BD common photodetecting portion 21 or a CD photodetecting portion provided in a CD hologram unit 13 which will be described below). The electric signal thus detected is output to the signal processing circuit 3 including a preamplifier, an RF signal processing circuit and an address signal processing circuit.

The RF signal processing circuit mainly processes a sum signal in the electric signal detected by the optical head device 2, thereby reproducing information such as user information which is recorded. In this case, a demodulating method includes a slice method and a PRML method. In other words, the signal processing circuit 3 (the RF signal processing circuit) functions as reading means for reading data recorded on the optical disc M.

The address signal processing circuit processes a detected signal to read physical address information indicative of a recording position on the optical disc and to output the same physical address information to the control portion 4. The control portion 4 reads information such as user information in a desirable position based on the address information and records the information such as the user information in the desirable position. In this case, the user information is modulated into data which are suitable for optical disc recording through a recording signal processing circuit constituting the recording waveform generating circuit 6. At this time, a modulating method, for example, a (1, 10) RLL (Run length limited) modulation or a (1, 7) RLL modulation is used for the data modulation. In the (1, 10) RLL modulation, the shortest code of 2 T and the longest code of 11 T are used in the data modulation. Furthermore, the recording waveform generating circuit 6 generates a signal for controlling a laser beam emitting waveform based on an input code and the LD driving circuit 5 drives an LD (laser driver) based on the laser beam emitting waveform control signal. Consequently, the information is recorded in the optical disc.

The servo circuit 8 generates servo signals such as focus, tracking and tilt signals based on the electric signal detected by the optical head device 2 and outputs the respective signals to actuators 20 for the focus, tracking and tilt in the optical head device 2.

The optical head device 2 includes an HD DVD/BD light source 11, a DVD light source 12, the CD hologram unit 13, a dichroic prism 14, a polarizing beam splitter (PBS) 15, a dichroic mirror 16, a collimating lens (CL) 17, a diffracting element 18 having a polarizing hologram optical element (HOE polarizing Holographic Optical Element) formed therein, an objective lens 19, the actuator 20, the DVD/HD DVD/BD common photodetecting portion 21, and a magnification converting lens 22 for converting a magnification for a CD. An element functioning as a λ/4 plate is laminated on the diffracting element 18.

The HD DVD/BD light source 11 includes a laser diode to be a semiconductor laser element and can emit a laser beam having a wavelength of approximately 405 nm (nanometers) corresponding to an HD DVD/BD, for example. Similarly, the DVD light source 12 includes a laser diode to be a semiconductor laser element and can emit a laser beam having a wavelength of approximately 650 nm corresponding to a DVD, for example.

The CD hologram unit 13 is a unit integrating a semiconductor laser capable of emitting a laser beam having a wavelength of approximately 780 nm corresponding to the CD, a photodiode for obtaining various servo signals, and a grating for dividing a light to obtain the servo signal, and serves to collect a light onto an optical disc, thereby obtaining a signal.

A laser beam emitted from the HD DVD/BD light source 11 is transmitted through the dichroic prism 14 and the polarizing beam splitter 15 and is reflected by the dichroic mirror 16, and is collimated (is changed into a parallel light) through the collimating lens 17. Then, the laser beam is transmitted through the diffracting element 18 and is guided to the objective lens 19. Since the objective lens 19 and the diffracting element 18 are held integrally, they are operated integrally.

A predetermined convergence is given to the laser beam guided to the objective lens 19 by means of the objective lens 19 and the laser beam is thus collected onto any of optional recording layers (L0 or L1) of the optical disc M. The respective recording layers of the optical disc M are provided with a guide groove at a pitch of 0.34 μm (micrometer) or 0.4 μm, that is, a track or a recording mark (recorded data) string concentrically or spirally, for example. Moreover, the objective lens 19 is formed of plastic, for example, and a numerical aperture is 0.65 in case of an HD DVD and is 0.85 in case of a BD.

The laser beam to which the predetermined convergence is given by the objective lens 19 is transmitted through a cover layer of the optical disc and is collected onto any of the recording layers. Consequently, the laser beam emitted from the HD DVD/BD light source 11 presents a minimum light spot in a focal position of the objective lens 19.

The objective lens 19 is placed in a predetermined position in a focusing direction to be a vertical direction of each of the recording layers in the optical disc M through an objective lens driving mechanism including a driving coil and a magnet, for example. A position control of the objective lens 19 to move the objective lens 19 in a track direction and to cause the minimum light spot of the laser beam to be coincident with a center of the track (the recording mark string) is referred to as a tracking control. Moreover, a position control of the objective lens 19 to move the objective lens 19 in the focusing direction and to cause a distance between the recording layer and the objective lens 19 to be coincident with a focal length of the objective lens 19 is referred to as a focus control.

The laser beam reflected by the optional recording layer of the optical disc M is captured by the objective lens 19 and is then converted to be almost parallel in a section taking a beam shape, and is returned to the diffracting element 18.

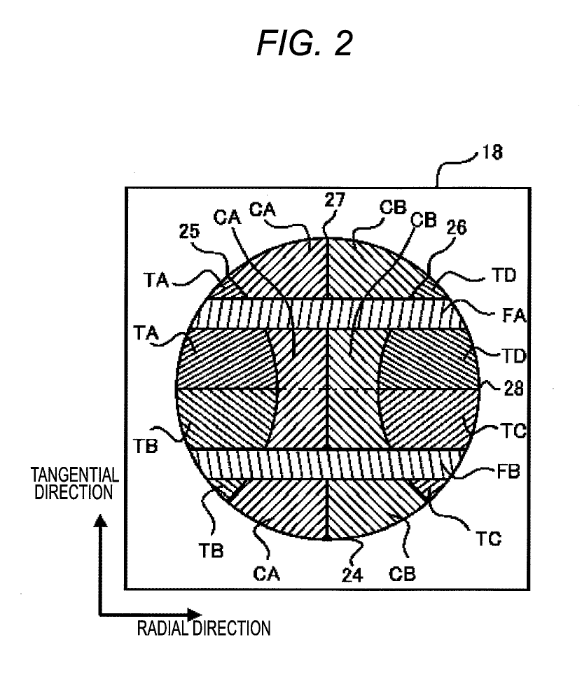

A diffracting region of the diffracting element 18 is defined to act on a reflected light having a polarizing direction which is different from an incident light by 90 degrees, and the light reflected from the optical disc M is divided and diffracted into a plurality of luminous fluxes. In other words, the optical beam in an outward course passes without a rare diffraction, and to the contrary, the light beam in a return course is diffracted. The diffracting element 18 is divided into predetermined regions shown in FIG. 2, for example, and the respective regions have different diffracting pitches and different diffraction grating directions. Each of the luminous fluxes diffracted by the diffracting element 18 is reflected by the dichroic mirror 16, and furthermore, is reflected by the polarizing beam splitter 15.

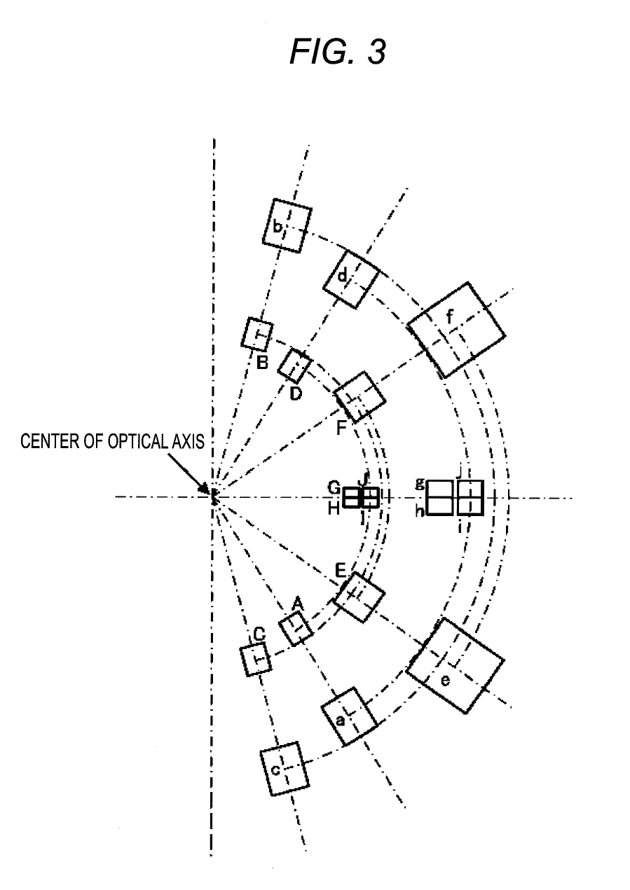

Images of the luminous fluxes are formed on the light receiving surface of the DVD/HD DVD/BD common photodetecting portion 21 through the convergence given by the collimating lens 17. At this time, the reflected luminous flux divided by the diffracting element 18 is collected corresponding to an array and a shape of a detecting region (a light receiving region) which is preset onto the light receiving surface of the DVD/HD DVD/BD common photodetecting portion 21. For example, in the case in which the detecting regions shown in FIG. 3 are arranged radially, for example, the luminous fluxes diffracted via regions FA and FB of the diffracting element 18 are collected onto a boundary portion between regions G and H and a boundary portion between regions J and I respectively, and a focus error signal is acquired by a so-called knife edge method. The focus error signal thus acquired is input to the signal processing circuit 3. Moreover, the luminous fluxes transmitted and diffracted through regions TA, TB, TC and TD are collected onto regions A, B, C and D on the DVD/HD DVD/BD common photodetecting portion 21 respectively, and a DPD (Differential Phase Detection) signal is acquired in case of an ROM disc and a PP (Push Pull) signal is acquired in case of R and RW discs. The signal thus acquired is input to the signal processing circuit 3. Moreover, the luminous fluxes transmitted and diffracted through regions CA and CB are collected onto regions E and F on the DVD/HD DVD/BD common photodetecting portion 21 respectively so that a compensation push pull signal for compensating for an offset of the PP signal through a lens shift of the objective lens 19 is obtained. Furthermore, the RF signal processing circuit of the signal processing circuit 3 adds all of the signals to obtain an RF signal.

The signal processing of the HD DVD/BD system is carried out as described above.

Similarly, a laser beam emitted from the DVD light source 12 is reflected by the dichroic prism 14 and almost passes through an optical path of the HD DVD/BD system, and is collected onto the recording surface of the optical disc M through the objective lens 19 and is thus reflected, and is then diffracted by the diffracting element 18. The luminous flux thus diffracted is received by the DVD/HD DVD/BD common photodetecting portion 21. However, a wavelength of the laser beam emitted from the DVD light source 12 is longer than that of the laser beam emitted from the HD DVD/BD light source 11. Consequently, a diffracting angle of the diffracting element 18 is greater than that of the HD DVD/BD system. For this reason, regions a to i are used for the light receiving region of the DVD/HD DVD/BD common photodetecting portion 21.

The signal processing of the DVD system is carried out as described above.

A laser beam emitted from the CD light source 13 is transmitted through the magnification converting lens 22 and the dichroic mirror 16 and is changed into an almost parallel light by the collimating lens 17. Furthermore, the laser beam passes through the diffracting element 18 and is guided to the objective lens 19. A convergence is given to the laser beam which is incident on the objective lens 19 and the same laser beam is collected onto the recording surface of the optical disc M. Moreover, the light reflected from the recording surface of the optical disc M passes through the same path as the outward course and is received by the CD photodetecting portion provided in the CD unit 13. The CD photodetecting portion converts the reflected light thus received into an electric signal and the signal processing circuit 3 carries out a signal processing based on the electric signal.

Subsequently, the structures and functions of the diffracting element 18 and the DVD/HD DVD/BD common photodetecting portion 21 will be described in more detail. As shown in FIG. 2, the diffracting element 18 is divided into the diffracting region FA to be a first focus error diffracting region, the diffracting region FB to be a second focus error diffracting region, the diffracting region group TA to be a first tracking error diffracting region group, the diffracting region group TB to be a second tracking error diffracting region group, the diffracting region group TC to be a third tracking error diffracting region group, the diffracting region group TD to be a fourth tracking error diffracting region group, the diffracting region group CA to be a first compensation push pull diffracting region group, and the diffracting region group CB to be a second compensation push pull diffracting region group. Although the diffracting element 18 is divided into 16 parts as shown in FIG. 2, it is functionally divided into the eight regions.

As shown in FIG. 3, the DVD/HD DVD/BD common photodetecting portion 21 has, for an HD DVD/BD, the first focus error photodetecting elements G and H, the second focus error photodetecting elements J and I, the first tracking error photodetecting element A, the second tracking error photodetecting element B, the third tracking error photodetecting element C, the fourth tracking error photodetecting element D, the first compensation push pull photodetecting element E and the second compensation push pull photodetecting element F.

As shown in FIG. 3, moreover, the DVD/HD DVD/BD common photodetecting portion 21 has, for a DVD, the first focus error photodetecting elements g and h, the second focus error photodetecting elements j and i, the first tracking error photodetecting element a, the second tracking error photodetecting element b, the third tracking error photodetecting element c, the fourth tracking error photodetecting element d, the first compensation push pull photodetecting element e, and the second compensation push pull photodetecting element f. The DVD/HD DVD/BD common photodetecting portion 21 has the respective photodetecting elements disposed radially to take a shape of a sector around the optical axis.

Lights separated by the diffracting regions FA and FB of the diffracting element 18 will be referred to as RFA and RFB respectively, lights separated by the diffracting regions TA, TB, TC and TD will be referred to as RTA, RTB, RTC and RTD respectively, and lights separated by the diffracting regions CA and CB will be referred to as RCA and RCB respectively. The lights RFA, RFB, RTA, RTB, RTC, RTD, RCA and RCB separated by the diffracting element 18 are detected by the respective photodetecting elements of the DVD/HD DVD/BD common photodetecting portion 21 and are converted into output signals (for example, current values in a photodiode), and an RF signal, an FE signal and a TE signal are generated by the signal processing circuit 3 based on the output signals.

Although a push pull method (PP) is used for a tracking error detecting method in the embodiment, a compensation push pull detecting method (CPP) is applied in consideration of an influence of the lens shift of the objective lens 19.

The PP signal is generated from signals output from the first tracking error photodetecting element A, the second tracking error photodetecting element B, the third tracking error photodetecting element C and the fourth tracking error photodetecting element D respectively through the signal processing circuit 3.

As shown in FIG. 2, the diffracting region group TA is obtained by removing the diffracting region FA from a region taking a shape of an almost half spindle surrounded by a circular outer edge 24, an arcuate dividing line 25, and a radial direction axis 28 passing through a center of the optical axis. The diffracting region group TB is obtained by removing the diffracting region FB from a region taking a shape of an almost half spindle surrounded by the circular outer edge 24, the arcuate dividing line 25 and the radial direction axis 28 passing through the center of the optical axis. The diffracting region group TC is obtained by removing the diffracting region FB from a region taking a shape of an almost half spindle surrounded by the circular outer edge 24, an arcuate dividing line 26 and the radial direction axis 28 passing through the center of the optical axis. The diffracting region group TD is obtained by removing the diffracting region FA from a region taking a shape of an almost half spindle surrounded by the circular outer edge 24, the arcuate dividing line 26 and the radial direction axis 28 passing through the center of the optical axis. As shown in FIG. 2, the diffracting regions FA and FB are parallel band-shaped regions in the radial direction of the optical disc respectively and are provided apart from each other in symmetrical positions with respect to the radial direction axis 28.

The diffracting region group TA diffracts the light RTA toward the first tracking error photodetecting element A. Moreover, the diffracting region group TA focuses the diffracted light RTA onto the photodetecting element A. The diffracting region group TB diffracts the light RTB toward the second tracking error photodetecting element B. Moreover, the diffracting region group TB focuses the diffracted light RTB onto the photodetecting element B. The photodetecting elements A and B are configured to receive the lights RTA and RTB in a state that the lights RTA and RTB are formed on the photodetecting elements A and B, and to output signals corresponding to intensities of the received light. Since the diffracting region groups TC and TD and the photodetecting elements C and D are also the same, description will be omitted.

The signal processing circuit 3 generates the tracking error signal (PP signal) by the PP method based on the outputs of the photodetecting element A and the photodetecting element B. Assuming that output signals obtained from the photodetecting elements A, B, C and D are represented by SA, SB, SC and SD respectively, a formula for computation of PP is PP=(SA+SB)−(SC+SD).

The compensation push pull signal required for generating the CPP signal is generated by the signals output from the first compensation push pull photodetecting element E and the second compensation push pull photodetecting element F through the signal processing circuit 3.

As shown in FIG. 2, the diffracting region group CA is obtained by removing the diffracting regions FA and FB from a region taking a shape of an almost plano-concave lens surrounded by the circular outer edge 24, the arcuate dividing line 25, and a tangential direction axis 27 passing through the center of the optical axis. The diffracting region group CB is obtained by removing the diffracting regions FA and FB from a region taking a shape of an almost plano-concave lens surrounded by the circular outer edge 24, the arcuate dividing line 26, and the tangential direction axis 27 passing through the center of the optical axis.

The diffracting region group CA diffracts the light RCA toward the first compensation push pull photodetecting element E. Moreover, the diffracting region group CA focuses the diffracted light RCA onto the photodetecting element E. The diffracting region group CB diffracts the light RCB toward the second compensation push pull photodetecting element F. Moreover, the diffracting region group CB focuses the diffracted light RCB onto the photodetecting element F. The photodetecting elements E and F receive the lights RCA and RCB in a state that the lights RCE and RCE are formed on the photodetecting elements E and F, and output signals corresponding to intensities of the received lights.

The signal processing circuit 3 outputs a compensation push pull signal required for generating the tracking error signal by the compensation push pull method (CPP method) based on the outputs of the photodetecting elements E and F. Assuming that the output signals obtained from the photodetecting elements E and F are represented by SE and SF respectively, a compensation value based on the compensation push pull signal is calculated in α(SE−SF) (α is a coefficient). Accordingly, the PP signal considering the compensation value based on the compensation push pull signal is calculated in PP=(SA+SB)−(SC+SD)−α(SE−SF).

The servo signal 8 controls the position of the objective lens 19 based on the tracking error signal received from the signal processing circuit 3 so that a light collecting position on L0 or L1 of the optical disc M for an incident light is set into a position of a just track.

Next, description will be given to an influence of an interlayer cross talk and a reducing method thereof. The laser beam guided to the objective lens 19 is collected onto the recording layer L0 or L1 of the optical disc M through the objective lens 19. When the laser beam is focused on L0, for example, a diffused light passing through L0 is irradiated on L1 so that a reflected light corresponding thereto is reflected and reaches the diffracting element 18. The light reflected from L1 is irradiated as a light in a so-called blurring state on the diffracting element 18. Although the light reflected from L1 is also diffracted by the diffracting element 18, it is collected in the blurring state in a shifted position which is different from a light collecting position of L0. For example, a light passing through the diffracting region TA in the reflected light of L1 reaches a shifted position from the photodetecting element A. The shift is more increased closer to an outer edge of the diffracting element 18. To the contrary, the shift is rarely generated in the vicinity of the center of the optical axis.

The light reflected from L1 is collected into a shift position from the collecting position of the reflected light of L0. When the light receiving area of the photodetecting element is increased, however, the light reflected from L1 is fetched so that the influence of the interlayer cross talk is exerted. To the contrary, by reducing the light receiving area of the photodetecting element, it is possible to remove the influence of the interlayer cross talk. In case of the diffracting pattern shown in FIG. 2, it is possible to remove the influence of the cross talk in a diffracting pattern provided apart from the center of the optical axis as in the diffracting regions FA, FB, and TA to TD.

On the other hand, the diffracting regions CA and CB include a portion in the vicinity of the center of the optical axis. Therefore, it is impossible to avoid the irradiation of the light reflected from L1. Consequently, the influence of the interlayer cross talk is exerted. The lights RCA and RCB diffracted by the diffracting regions CA and CB are collected by the photodetecting elements E and F, and a compensation value (α(SE−SF)) based on the compensation push pull signal is generated from the output signals. By the interlayer cross talk, the compensation value is subjected to a fluctuation.

FIG. 4 is a chart showing a simulation result of a cross talk on a recording/non-recording boundary from another layer in the case in which the diffracting element 18 is not used. The optical disc is an HD DVD. An axis of abscissas indicates a distance from the recording/non-recording boundary from another layer and an axis of ordinates indicates a quantity of a detected light in each of the photodetecting elements E and F. A great interlayer cross talk is particularly generated in a boundary portion between a recorded region and a non-recorded region in another layer which is not subjected to focusing. For example, it is assumed that the light is focused on the L0 layer and the L1 layer has the recording/non-recording boundary portion. By the influence of the cross talk from the L1 layer, the quantity of the detected light in each of the photodetecting elements E and F greatly fluctuates so that a compensation push pull value is greatly changed. In some cases, therefore, a tracking servo becomes unstable.

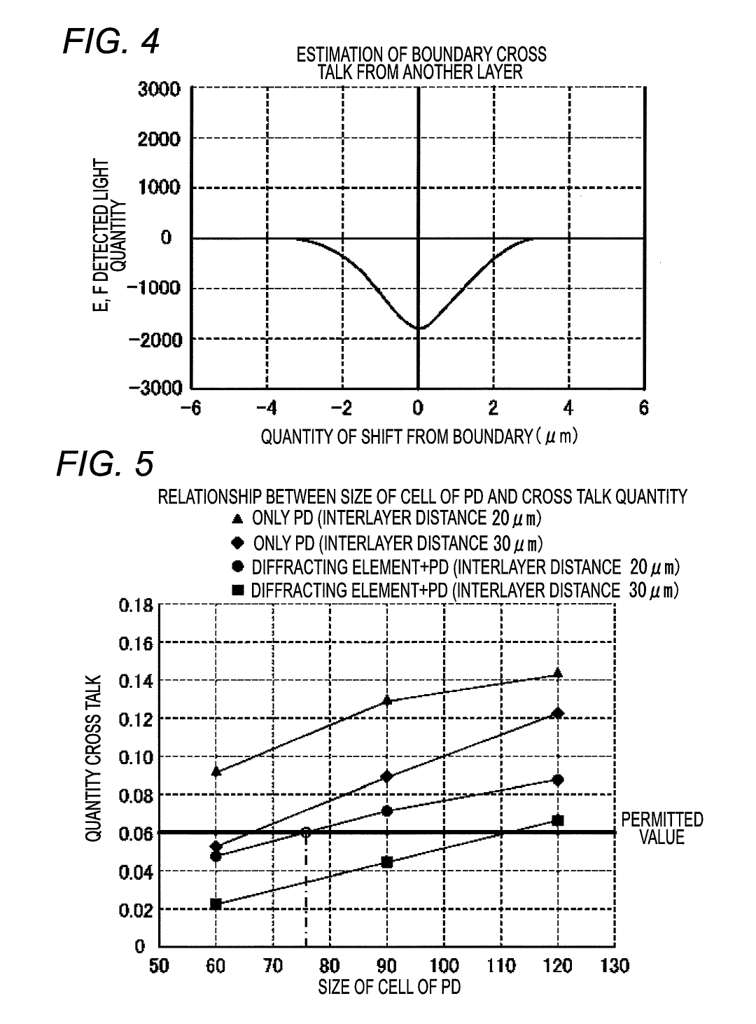

FIG. 5 is a chart showing results obtained by carrying out a simulation in the case in which the diffracting element 18 is used and the case in which the diffracting element 18 is not used and in the case in which an interlayer distance is 30 μm and the case in which the interlayer distance is 20 μm for a relationship between a size of a cell of a PD and a cross talk quantity by using a photo detector (PD) as a photodetecting portion, respectively. First, the cross talk quantity is smaller in the case in which the diffracting element 18 is used as compared with the case in which the diffracting element 18 is not used. The reason is that a reflected light in the central portion of the optical axis can be irradiated on the photodetecting element (the cell of the PD in this case) by shifting a reflected light in a portion provided apart from the center of an inner optical axis of a reflected light from another layer by using the diffracting element 18. The cross talk quantity is smaller in the case in which the interlayer distance is 30 μm as compared with the case in which the interlayer distance is 20 μm.

In FIG. 5, a servo permitted value is preferably equal to or smaller than approximately 6% in order to operate the tracking servo of the optical disc apparatus 1 sufficiently stably. In some cases, the tracking servo is unstable by the influence of the interlayer cross talk when the servo permitted value is greater than approximately 6%. A size of the cell of the PD is equal to or smaller than approximately 75 μm in one side when the PD has a square shape in order to obtain a permitted value of 6% or less when the interlayer distance is 20 μm. As shown in FIG. 3, accordingly, it is desirable that the size of each of the photodetecting elements E and F should be equal to or smaller than 75 μm in one side in case of the photodetecting elements has a square shape when the respective photodetecting elements of the DVD/HD DVD/BD common photodetecting portion 21 are disposed radially around the optical axis. Each of the photodetecting elements E and F may take a rectangular shape, a shape in which an apex portion of the rectangle is chamfered linearly or arcuately, or a circular shape, an oval shape or an elliptical shape if an area is equal to or smaller than 5625 micrometers square. In order to control an aberration distortion of a return course optical system, moreover, it is desirable that all of the cells of the PD should be disposed in a circle having a radius of 1 mm or less.

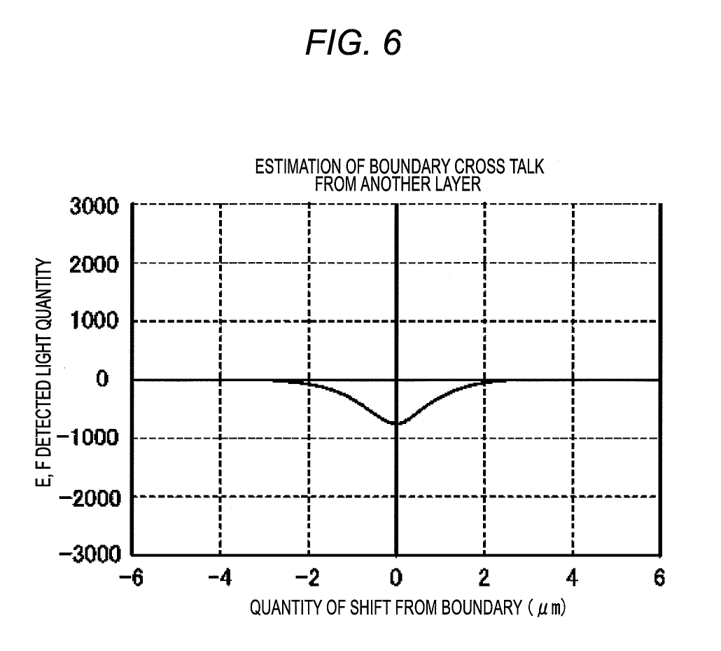

FIG. 6 is a chart showing a simulation result for a cross talk of a recording/non-recording boundary from another layer in the case in which the size of the cell of the PD in each of the photodetecting elements E and F is set to be equal to or smaller than 75 μm in one side when the PD has a square shape by using the diffracting element 18 arranged as shown in FIG. 2. A fluctuation in the quantity of the detected light in each of the photodetecting elements E and F shown in FIG. 4 is reduced.

As described above, two compensation push pull signal diffracting regions CA and CB are disposed in the central part, four tracking error diffracting regions TA, TB, TC and TD are disposed along the outer edge and two focus error diffracting regions FA and FB are disposed apart from the center of the optical axis in parallel with the radial direction axis 28 in the arrangement of the diffracting regions of the diffracting element 18 as shown in FIG. 2 and the respective photodetecting elements of the DVD/HD DVD/BD common photodetecting portion 21 are arranged radially around the optical axis, and the size of each of the compensation push pull photodetecting elements E and F is set to be equal to or smaller than 75 μm in one side when the PD has a square shape and the light receiving area is set to be equal to or smaller than 5625 micrometers square in case of a shape other than the square shape as shown in FIG. 3. Thus, it is possible to control the interlayer cross talk while ensuring an easiness of an assembly and an adjustment. Even if the interlayer distance of the optical disc is 20 μm, the influence of the cross talk on the recording/non-recording boundary of another layer can be reduced into a permitted range of the optical disc apparatus. Thus, it is possible to carry out a stable recording and reproducing operation.

The invention is not exactly restricted to the embodiment but the components can be changed and made concrete without departing from the scope in an executing stage. By a proper combination of the components disclosed in the embodiment, moreover, it is possible to form various inventions. For example, some of all the components described in the embodiment may be deleted. Furthermore, the arrangement of each of the photodetecting elements shown in FIG. 3 is illustrative. Even if each of the respective photodetecting elements is arranged in a different place from the place shown in FIG. 3, it is possible to irradiate a reflected light on each of the photodetecting elements by a design of each of the diffracting regions in the diffracting element 18.

As described with reference to the embodiment, there is provided an optical head device and an optical disc apparatus which can suppress an interlayer cross talk while ensuring an easiness of an assembly and an adjustment.

According to the above embodiment, it is possible to provide an optical head device and an optical disc apparatus which can suppress an interlayer cross talk while ensuring an easiness of an assembly and an adjustment.

What is claimed is:

1. An optical head device comprising:
a diffraction module comprising a plurality of diffraction portions each configured to diffract an incident light in a given direction, the light beam being reflected by an optical disc; and
a plurality of photodetectors each configured to output a signal corresponding to an intensity of an irradiated light,
wherein the photodetectors comprise at least two first photodetectors for generating a compensation value in order to compensate a tracking error signal, and
the diffraction portions comprise at least two first diffraction portions for focusing the incident light into the first photodetectors.

2. The optical head device of claim 1, wherein each of the first photodetectors comprises a shape of a square in which a length of one side is equal to or smaller than 75 micrometers.

3. The optical head device of claim 1, wherein an area of each of the first photodetectors is equal to or smaller than 5625 micrometers square.

4. The optical head device of claim 1,
wherein the photodetectors comprise a plurality of second photodetectors for generating the tracking error signal,
the diffraction portions comprise a plurality of second diffraction portions for focusing the incident light into the second photodetectors,
the photodetectors comprise a plurality of third photodetectors for generating a focus error signal, and
the diffraction portions comprise a plurality of third diffraction portions for focusing the incident light into the third photodetectors.

5. The optical head device of claim 4, wherein each of the first photodetectors comprises a shape of a square in which a length of one side is equal to or smaller than 75 micrometers.

6. The optical head device of claim 4, wherein an area of each of the compensation photodetectors is equal to or smaller than 5625 micrometers square.

7. The optical head device of claim 4, wherein the first, second, and third photodetectors are radially around an optical axis of the light beam.

8. An optical disc apparatus comprising an optical head device and a controller configured to perform processing of a signal output from the optical head device, an optical head device comprising:
a diffraction module comprising a plurality of diffraction portions each configured to diffract an incident light in a given direction, the light beam being reflected by an optical disc; and
a plurality of photodetectors each configured to output a signal corresponding to an intensity of an irradiated light,
wherein the photodetectors comprise at least two first photodetectors for generating a compensation value in order to compensate a tracking error signal, and
the diffraction portions comprise at least two first diffraction portions for focusing the incident light into the first photodetectors.

9. The optical disc apparatus of claim 8, wherein each of the first photodetectors comprise a shape of a square in which a length of one side is equal to or smaller than 75 micrometers.

10. The optical disc apparatus of claim 8, wherein an area of each of the first photodetectors has is equal to or smaller than 5625 micrometers square.

11. The optical disc apparatus of claim 8,
wherein the photodetectors comprise a plurality of second photodetectors for generating the tracking error signal,
the diffraction portions comprise a plurality of second diffraction portions for focusing the incident light into the second photodetectors,
the photodetectors comprise a plurality of third photodetectors for generating a focus error signal, and
the diffraction portions comprise a plurality of third diffraction portions for focusing the incident light into the third photodetectors.

12. The optical disc apparatus of claim 11, wherein each of the first photodetectors comprises a shape of a square in which a length of one side is equal to or smaller than 75 micrometers.

13. The optical disc apparatus of claim 11, wherein an area of each of the compensation photodetectors is equal to or smaller than 5625 micrometers square.

14. The optical disc apparatus of claim 11, wherein the first, second, and third photodetectors are radially around an optical axis of the light beam.
